(19) United States
(12) Patent Application Publication
(10) Pub. No.: US 2011/0215994 A1
(43) Pub. Date: Sep. 8, 2011

(54) LIQUID CRYSTAL DISPLAY DEVICE

(75) Inventors: Hyun-Uk Oh, Yongin-city (KR); Ji-Suk Lim, Yongin-city (KR)

(73) Assignee: Samsung Mobile Display Co., Ltd., Yongin-city (KR)

(21) Appl. No.: 13/037,245

(22) Filed: Feb. 28, 2011

(30) Foreign Application Priority Data
Mar. 5, 2010 (KR) 10-2010-0020058

(51) Int. Cl. G09G 3/36

(52) U.S. Cl. 345/92; 345/87

(57) ABSTRACT

A liquid crystal display (LCD) device is disclosed. The LCD device includes a noise removal unit configured to reduce noise coupled to the data lines.

### CROSS-REFERENCE TO RELATED APPLICATIONS

This application claims the benefit of Korean Patent Application No. 10-2010-0020058, filed on Mar. 5, 2010, in the Korean Intellectual Property Office, the disclosure of which is incorporated herein in its entirety by reference.

### BACKGROUND

1. Field

The disclosed technology relates to a display device, and more particularly, to a liquid crystal display (LCD) device with a noise removal unit.

2. Description of the Related Technology

In general, a liquid crystal display (LCD) device displays an image by using an electric field to adjust optical transmittance of a liquid crystal. For this, the LCD device includes a liquid crystal panel (where a plurality of pixels with liquid crystal capacitors are arranged in a matrix) and a driving circuit for driving the liquid crystal panel.

However, parasitic capacitances occur in the liquid crystal panel because of inevitably-formed wiring intersections and due to this, signals are adversely affected by couplings of other signals. The noise caused by the capacitive coupling causes various undesired image affects.

### SUMMARY OF CERTAIN INVENTIVE ASPECTS

One inventive aspect is a liquid crystal display (LCD) device. The LCD device includes a liquid crystal panel having a plurality of pixel circuits, the pixel circuits being near intersections of a plurality of gate lines and data lines. The LCD device also includes a common voltage supplying unit configured to supply a common voltage to the pixel circuits, and a noise removal unit configured to reduce noise coupled between the gate lines and the data lines.

Another inventive aspect is a liquid crystal display (LCD) device, which includes a liquid crystal panel having a plurality of pixel circuits, the pixel circuits being near intersections of a plurality of gate lines, data lines, and active level shift (ALS) lines. The LCD device also includes a common voltage supplying unit configured to supply a common voltage to the pixel circuits, and a noise removal unit configured to reduce noise coupled between the ALS lines and the data lines.

Another inventive aspect is a liquid crystal display (LCD) device, which includes a liquid crystal panel having a plurality of pixel circuits, the pixel circuits being near intersections of a plurality of gate lines and data lines. The LCD device also includes a common voltage supplying unit configured to supply a common voltage to the plurality of pixel circuits with a common voltage line, and a noise removal unit configured to reduce noise coupled between the common voltage line and the data lines.

### BRIEF DESCRIPTION OF THE DRAWINGS

The above and other features and advantages are discussed in the context of certain exemplary embodiments with reference to the attached drawings in which:

FIG. 1 is a block diagram illustrating a configuration of a liquid crystal display (LCD) device according to an embodiment;

FIG. 2 is a circuit diagram and a timing diagram illustrating a pixel circuit and its driving waveform according to an embodiment;

FIG. 3 is a circuit diagram illustrating the noise removal unit of FIG. 1;

FIG. 4 is a block diagram illustrating a configuration of an LCD device according to another embodiment;

FIG. 5 is a waveform diagram illustrating noise reduced by a noise removal unit; and

FIG. 6 is a block diagram illustrating a configuration of an LCD device according to another embodiment.

### DETAILED DESCRIPTION OF CERTAIN INVENTIVE EMBODIMENTS

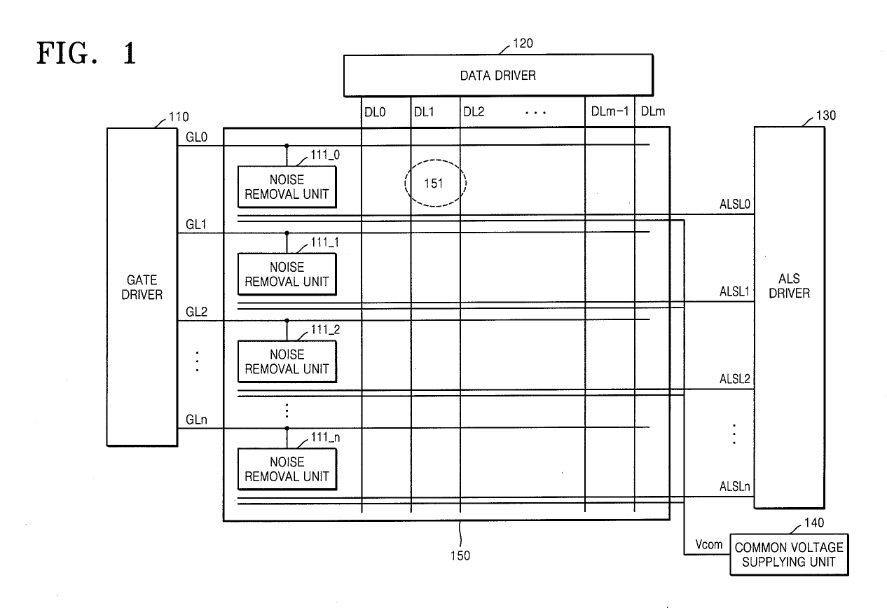

FIG. 1 is a block diagram illustrating a configuration of a liquid crystal display (LCD) device according to a first embodiment.

Referring to FIG. 1, the LCD device includes a gate driver 110, a data driver 120, an active level shift (ALS) driver 130, a common voltage supplying unit 140, and an LCD panel 150.

The gate driver 110 supplies gate voltages to the LCD panel 150 through a plurality of gate lines GL1, GL2, . . . , GLn. The plurality of gate lines GL1, GL2, . . . , GLn are arranged in a horizontal direction with respect to the LCD panel 150 and are electrically connected to pixel circuits 151. The gate lines GL1, GL2, . . . , GLn extend from the first data line DL1 to the mth data line DLm and supply a gate voltage to the pixel circuits 151. Because of signal propagation delay, the pixel circuits 151 that are electrically connected to the first data line DL1 have the shortest gate voltage delay time and the pixel circuits 151 that are electrically connected to the mth data line DLm have the longest gate voltage delay time.

The data driver 120 supplies a data voltage to the LCD panel 150 through a plurality of data lines DL1, DL2, . . . DLm−1, DLm. The plurality of data lines DL1, DL2, . . . DLm−1, DLm are arranged in a vertical direction with respect to the LCD panel 150 and are electrically connected to the pixel circuits 151.

The ALS driver 130 supplies an ALS voltage to the LCD panel 150 through a plurality of ALS lines ALSL1, ALSL2, . . . ALSLn. The plurality of ALS lines ALSL1, ALSL2, . . . ALSLn are arranged in a horizontal direction with respect to the LCD panel 150 and are electrically connected to the pixel circuits 151. The ALS lines ALSL1, ALSL2, . . . ALSLn extend from the mth data line DLm to the first data line DL1 and supply an ALS voltage to the pixel circuits 151. Because of signal propagation delay, the pixel circuits 151 that are connected to the mth data line DLm have the shortest ALS voltage delay time and the pixel circuits 151 that are connected to the first data line DL1 have the longest ALS voltage delay time.

The common voltage supplying unit 140 generates and supplies a common voltage, which is a reference voltage during driving of a liquid crystal cell. A plurality of common voltage lines VcomL1, VcomL3, . . . , VcomLn are arranged in a horizontal direction with respect to the LCD panel 150 and are electrically connected to the pixel circuits 151.

The LCD panel 150 includes the gate lines GL1, GL2, . . . , GLn, the ALS lines ALSL1, ALSL2, ALSLn, and the common voltage lines VcomL1, VcomL3, . . . , VcomLn (all of which are arranged in the horizontal direction), the data lines DL1, DL2, . . . , DLm−1, DLm (which are arranged in the vertical direction), and the pixel circuits 151. Furthermore, the LCD panel 150 includes noise removal units 111_1, 111_2, . . . 111_{—}n for reducing the noise effect of parasitic capacitances caused by wiring intersections of the gate lines GL1, GL2, . . . , GLn and the data lines DL1, DL2, . . . DLm−1, DLm.

Here, the pixel circuit 151 may be formed near a pixel region defined by the adjacent gate line, data line, ALS line, and common voltage line. As mentioned above, the gate driver 110 supplies a gate voltage to the gate lines GL1, GL2, . . . , GLn, and the data driver 120 supplies a data voltage to the data lines DL1, DL2, . . . DLm−1, DLm and the ALS driver 130 supplies an ALS voltage to the ALS lines ALSL1, ALSL2, . . . ALSLn, and the common voltage supplying unit 140 supplies a common voltage to the common voltage lines VcomL1, VcomL3, . . . , VcomLn.

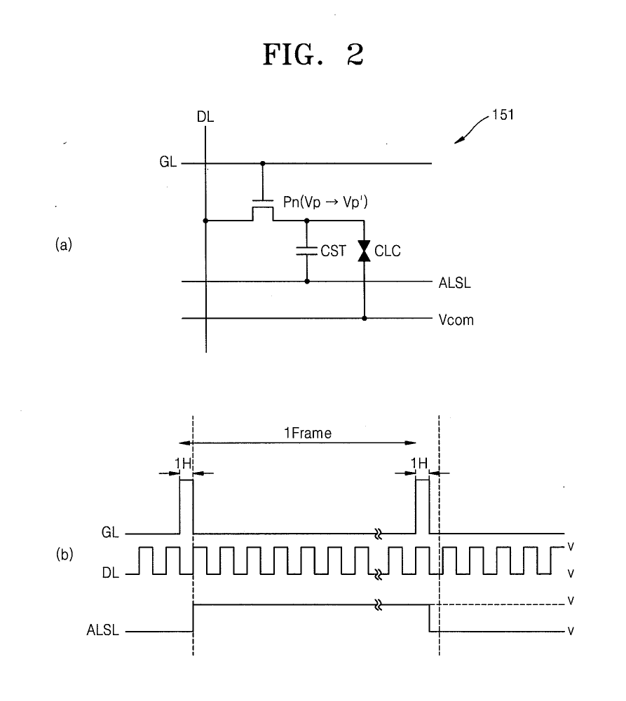

FIG. 2 is a circuit diagram and timing diagram illustrating the pixel circuit 151 and its driving waveform, according to an embodiment.

An embodiment of pixel circuit 151 and its drive waveforms in the LCD device of FIG. 1 are shown in FIG. 2. The pixel circuit 151 includes a thin film transistor (TFT), a cholesteric liquid crystal (CLC) device, and a capacitor CST.

In the TFT, a gate electrode is electrically connected to the gate line GL, and a first electrode (a drain electrode or a source electrode) is electrically connected to the data line DL, and a second electrode (a source electrode or a drain electrode) is electrically connected to a pixel electrode Pn. The TFT is turned on when a gate voltage of a high level is applied to the gate electrode and thus delivers a data voltage applied from the data line to the pixel electrode Pn.

In the CLC, a first electrode is electrically connected to the pixel electrode Pn and a second electrode is electrically connected to the common voltage line Vcom. The liquid crystal device CLC prevents light or adjusts the amount of light, which is transmitted when alignment of liquid crystal molecules in a liquid crystal layer are changed due to an electric field induced by a data voltage applied to the pixel electrode Pn and a common voltage applied to the common voltage line Vcom.

In the capacitor CST, a first electrode is electrically connected to the pixel electrode Pn and a second electrode is electrically connected to the ALS line ALSL. The capacitor CST stores an electric charge quantity, which corresponds to a voltage difference between the pixel electrode Pn and the ALS line when a gate voltage of a high level is applied to the gate electrode of the TFT to turn on the TFT and a data voltage is applied to the pixel electrode Pn. The voltage charged in the capacitor CST is applied to the pixel electrode Pn to maintain the driving of a liquid crystal and the pixel electrode Pn is floated while the TFT is turned off by applying a gate voltage of a low level to the gate electrode of the TFT. The electric charge quantity of the capacitor CST is determined by a voltage difference between the pixel electrode Pn and the ALS line.

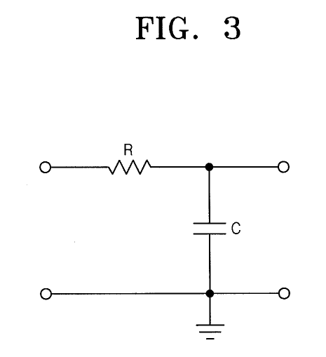

LCD devices generally adapt a matrix driving method as described with reference to FIG. 1 and thus have points where the horizontally arranged gate lines GL1, GL2, . . . , GLn and the vertically arranged data lines DL1, DL2, . . . DLm−1, DLm intersect each other. The noise caused by parasitic capacitive coupling of high frequency signals occurs and thus image quality is deteriorated. In order to prevent the noise caused by the coupling, the noise removal units 111_1, 111_2, . . . , 111_{—}n are respectively connected to the gate lines GL1, GL2, . . . , GLn in the LCD panel 150. The noise removal units 111_1, 111_2, . . . 111_{—}n may include a resistor component and a capacitor component which form an RC filter, that is, a low pass filter, as shown in FIG. 3. The noise removal units 111_1, 111_2, . . . 111_{—}n filter high frequency components of the gate voltage signals from the gate driver 110. Accordingly, the high frequency components do not pass to the points where the horizontally arranged gate lines GL1, GL2, . . . , GLn and the vertically arranged data lines DL1, DL2, . . . DLm−1, DLm intersect each other. As a result, the high frequency components do not couple to adjacent lines. Accordingly, noise is reduced and excellent image quality is achieved.

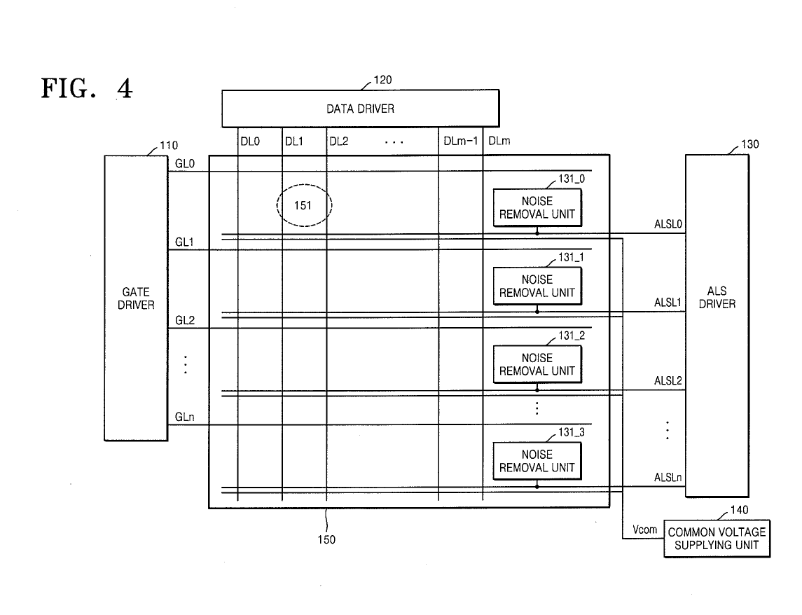

FIG. 4 is a block diagram illustrating a configuration of an LCD device according to another embodiment. In this embodiment, the noise removal units 131_1, 131_2, . . . , 131_{—}n are respectively connected to the ALS lines ALSL1, ALSL2, . . . ALSLn in the LCD panel 150.

An ALS driving mode raises a voltage Vp of the pixel electrode Pn in FIG. 2 through the ALS line. Through coupling of the voltage of the ALS line to the electrode Pn that floats after a gate voltage turns off the TFT, the voltage Vp of the pixel electrode Pn is raised by one positive frame or is dropped by one negative frame. The ALS driving method may allow for reduced data voltage on the data lines DL1, DL2, . . . , DLm−1, DLm such that power consumption is reduced and an actual pixel voltage is increased. In addition, response time of the liquid crystal can be improved by applying a high pixel voltage. Moreover, since the boosted voltage Vp′ is sufficient, a common voltage may be applied as direct current (DC) such that audible noise, a big issue of a common voltage toggle, can be reduced.

However, as shown in FIG. 4, the ALS lines ALSL1, ALSL2, . . . ALSLn are parallel to the gate lines GL1, GL2, . . . , GLn and thus there are points where the data lines DL1, DL2, DLm−1, . . . DLm and ALS lines ALSL1, ALSL2, . . . ALSLn intersect each other. Due to this, an ALS voltage that needs to be applied as a DC voltage during one frame causes noise because of data line coupling. If there is noise in the ALS line, the boosted voltage Vp′ of the pixel electrode Pn has noise and a flicker phenomenon occurs.

Accordingly, in order to resolve the flicker phenomenon, noise removal units 131_1, 131_2, . . . , 131_{—}n are respectively connected to the ALS lines ALSL1, ALSL2, . . . ALSLn in the LCD panel 150. The noise removal units 131_1, 131_2, . . . 131_{—}n may include an RC filter, that is, a low pass filter, as shown in FIG. 3. The noise removal units 131_1, 131_2, . . . 131_{—}n remove the high frequency components of the ALS signals which cause the flicker phenomenon. As a result, an excellent image quality can be achieved.

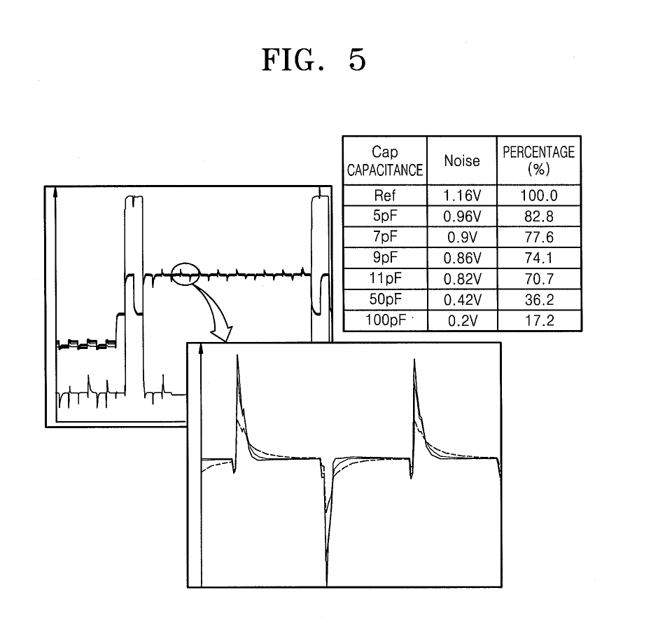

FIG. 5 is a waveform diagram illustrating noise reduction for various capacitances of the noise removal units 131_1, 131_2, . . . 131_{—}n. Referring to FIG. 5, noise reduction is degraded by about 65% if the capacitance is reduced by 50 pF from the reference, and noise reduction is degraded by about 84% if the capacitance is reduced by 100 pF from the reference.

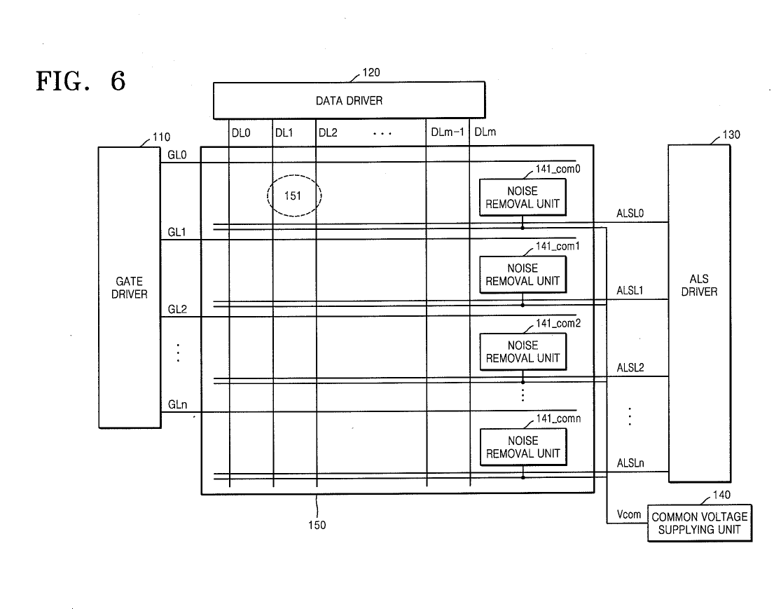

FIG. 6 is a block diagram illustrating a configuration of an LCD device according to another embodiment. In the LCD device of the embodiment of FIG. 6, each noise removal unit 141_com1, 141_com2, 141_comn is connected to the common voltage line Vcom.

As shown in FIG. 6, the common voltage line Vcom is parallel to the gate lines GL1, GL2, . . . , GLn and thus there are points where the data lines DL1, DL2, . . . DLm−1, DLm and the common voltage line Vcom intersect each other. Due to this, noise caused by the parasitic capacitances occurs and thus, flicker is generated. As a result, image quality is affected. In order to reduce the noise caused by the parasitic capacitances, the noise removal units 141_com1, 141_com2, . . . , 141_comn is connected to the common voltage line Vcom in the LCD panel 150. The noise removal units 141_com1, 141_com2, . . . , 141_comn may include an RC filter, that is, a low pass filter, as illustrated in FIG. 3. The noise removal units 141 com0, 141_com1, 141_com2, . . . , 141_comn filter out high frequency components on the common voltage line Vcom preventing the high frequency components from reaching points where the horizontally-arranged common voltage line Vcom and the vertically-arranged data lines DL1, DL2, . . . , DLm−1, DLm intersect each other. Thus, excellent image quality can be achieved.

In some embodiments, noise removal units are connected to one or more of the common voltage lines VcomL1, VcomL3, . . . , VcomLn and one or more of the ALS lines ALSL1, ALSL2, . . . ALSLn. In some embodiments, noise removal units are connected to one or more of the common voltage lines VcomL1, VcomL3, . . . , VcomLn and one or more of gate lines GL1, GL2, . . . , GLn. In some embodiments, noise removal units are connected to one or more of the ALS lines ALSL1, ALSL2, . . . ALSLn and one or more of gate lines GL1, GL2, . . . , GLn. In some embodiments, noise removal units are connected to one or more of the common voltage lines VcomL1, VcomL3, . . . , VcomLn, one or more of the ALS lines ALSL1, ALSL2, . . . , ALSLn, and one or more of gate lines GL1, GL2, . . . , GLn.

According to the current embodiments, the LCD device has one gate driver on the left side and one ALS driver on the right side. In other embodiments, the LCD device may also have two gate drivers with one disposed on each of the left and right sides and two ALS drivers with one disposed on each of the left and right sides. In this case, odd gate lines of the gate lines GL1, GL2, . . . , GLn extend from the mth data line DLm to the first data line DL1 and supply a gate voltage to the pixel circuits 151. Even gate lines of the gate lines GL1, GL2, . . . , GLn extend from the first data line DL1 to the mth data line DLm and supply a gate voltage to the pixel circuits 151. Extension directions of the odd gate lines and the even gate lines may be opposite. Because of signal propagation delay, in the odd gate lines, the pixel circuits 151 that are electrically connected to the mth data line DLm have the shortest gate voltage delay time and the pixel circuits 151 that are electrically connected to the first data line DL1 have the longest gate voltage delay time. Likewise, in the even gate lines, the pixel circuits 151 that are electrically connected to the first data line DL1 have the shortest gate voltage delay time and the pixel circuits 151 that are electrically connected to the mth data line DLm have the longest gate voltage delay time. Odd ALS lines of the ALS lines ALSL1, ALSL2, . . . ALSLn extend from the mth data line DLm to the first data line DL1 and supply an ALS voltage to the pixel circuits 151. Even ALS lines of the ALS lines ALSL1, ALSL2, . . . ALSLn extend from the first data line DL1 to the mth data line DLm and supply an ALS voltage to the pixel circuits 151. Extension directions of the odd ALS lines and the even ALS lines may be opposite. Because of signal propagation delay, in the odd ALS lines, the pixel circuits 151 that are connected to the mth data line DLm have the shortest ALS voltage delay time and the pixel circuits 151 that are connected to the first data line DL1 have the longest ALS voltage delay time. Likewise, for the even ALS lines, the pixel circuits 151 that are connected to the first data line DL1 have the shortest ALS voltage delay time and the pixel circuits 151 that are connected to the mth data line DLm have the longest ALS voltage delay time.

As mentioned above, noise coupled by parasitic capacitances, which occurs at points where a gate line and a data line intersect, an ALS line and a data line intersect, and/or a common voltage line and a data line intersect each other, is removed to improve image quality.

Devices using the various inventive aspects may include a processor, a memory for storing and executing program data, a permanent storage such as a disk drive, a communication port for communicating with an external device, a user interface device such as a touch panel, keys, or buttons, and so forth. Various kinds of methods, which are implemented with software modules or algorithms, may be stored in a computer-readable recording medium as computer-readable codes or program commands that are executable by the processor. Herein, examples of the computer-readable recording medium include magnetic storage media (e.g., read-only memory (ROM), random access memory (RAM), floppy disks, hard disks and so forth) and optical reading media (e.g., CD-ROMs, Digital Versatile Discs (DVDs) and so forth). The software instructions may be distributed over computers connected via a network, and computer-readable codes may be stored and executed through such means of distribution. The medium is readable by a computer, instructions are stored in the memory, and are executed by the processor.

While reference numerals are included for exemplary embodiments in the drawings and specific terms are used to describe the embodiments to provide a clear understanding of various inventive aspects, the inventive aspects and embodiments are not limited by the specific terms used and may include all elements that may be conceived by those skilled in the art.

The various aspects may be represented, actualized, or practiced with functional block configurations and various processing steps. The functional blocks may be realized with different numbers of hardware or/and software components for executing specific functions. For example, certain embodiments may adopt integrated circuit components such as a memory, processor, logic, and look-up table, which may execute various functions through control of one or more microprocessors or other control devices. As the components of the embodiments may be practiced and executed by software programming or software components, so may the components be realized by programming languages such as C, C++, Java, and assembler or scripting languages, with diverse algorithms realized through combining data structures, processors, routines, or other programming components. Functional aspects may be realized with an algorithm executed by at least one processor. In addition, embodiments may adopt techniques for electronic environment settings, signal processing, and/or data processing. Terms such as mechanism, component, means, and configuration may be broadly used and are not limited to mechanical and physical constituents. The terms may mean a series of routines of software in connection to a processor.

Specific aspects are described in the context of specific embodiments, and do not limit the scope of practiced embodiments. For conciseness of the specification, description of conventional electronic configurations, control systems, software, and other functional aspects of systems may be omitted. Moreover, connections of lines or connecting elements between components shown in the accompanying drawings may represent functional connections and/or physical or circuit connections, and may represent various kinds of replaceable or additional functional connections, physical connections, or circuit connections in an actual device. Furthermore, if not specifically described using terms such as “essentially” or “importantly”, elements described in the specification may not be necessarily required for application of the inventive aspects.

In some instances, the term “the” and similar indicative terms may be applicable to both the singular and the plural. Moreover, if the present invention lists a range, it includes all embodiments in which individual values within the range are applied (if not stated otherwise) and means that each individual value constituting the range is included in the detailed description of the embodiments. In addition, if operations constituting a method according to the inventive aspects are not described clearly as being in a required sequence or if no contradictory description is provided, the operations may be performed in any suitable sequence, and embodiments are not limited to the sequence in which the operations are described. All examples or exemplary terms (“for example” and “so forth”) are used solely to describe the inventive aspects in detail and do not limit the scope of practiced embodiments. In addition, it will be apparent to those skilled in the art that various modifications, combinations, and alterations may be made in accordance with design parameters and factors.

What is claimed is:

1. A liquid crystal display (LCD) device comprising:
a liquid crystal panel comprising a plurality of pixel circuits, the pixel circuits being near intersections of a plurality of gate lines and data lines;
a common voltage supplying unit configured to supply a common voltage to the pixel circuits; and
a noise removal unit configured to reduce noise coupled between the gate lines and the data lines.

2. The LCD device of claim 1, wherein the noise removal unit is on the liquid crystal panel.

3. The LCD device of claim 2, wherein the noise removal unit is connected to each of the gate lines.

4. The LCD device of claim 2, wherein the noise removal unit comprises a low pass filter.

5. The LCD device of claim 1, wherein the pixel circuit comprises:
a thin film transistor (TFT) comprising a gate electrode connected to a gate line and a first electrode connected to a data line;
a capacitor comprising a first electrode connected to a second electrode of the TFT and a second electrode connected to an active level shift (ALS) line; and
a liquid crystal device comprising a first electrode connected to the second electrode of the TFT and a second electrode connected to a common voltage line.

6. A liquid crystal display (LCD) device comprising:
a liquid crystal panel comprising a plurality of pixel circuits, the pixel circuits being near intersections of a plurality of gate lines, data lines, and active level shift (ALS) lines;
a common voltage supplying unit configured to supply a common voltage to the pixel circuits; and
a noise removal unit configured to reduce noise coupled between the ALS lines and the data lines.

7. The LCD device of claim 6, wherein the noise removal unit is on the liquid crystal panel.

8. The LCD device of claim 7, wherein the noise removal unit is connected to each of the ALS lines.

9. The LCD device of claim 7, wherein the noise removal unit comprises a low pass filter.

10. The LCD device of claim 6, wherein the pixel circuit comprises:
a thin film transistor (TFT) comprising a gate electrode connected to a gate line and a first electrode connected to a data line;
a capacitor comprising a first electrode connected to a second electrode of the TFT and a second electrode connected to an ALS line; and
a liquid crystal device comprising a first electrode connected to the second electrode of the TFT and a second electrode connected to a common voltage line.

11. The LCD device of claim 6, wherein the noise removal unit is further configured to reduce noise coupled between the gate lines and the data lines.

12. A liquid crystal display (LCD) device comprising:
a liquid crystal panel comprising a plurality of pixel circuits, the pixel circuits being near intersections of a plurality of gate lines and data lines;
a common voltage supplying unit configured to supply a common voltage to the plurality of pixel circuits with a common voltage line; and
a noise removal unit configured to reduce noise coupled between the common voltage line and the data lines.

13. The LCD device of claim 12, wherein the noise removal unit is on the liquid crystal panel.

14. The LCD device of claim 13, wherein each of the noise removal unit is connected to the common voltage line.

15. The LCD device of claim 13, wherein the noise removal unit has a low pass filter property.

16. The LCD device of claim 12, wherein the pixel circuit comprises:
a thin film transistor (TFT) comprising a gate electrode connected to a gate line and a first electrode connected to a data line;
a capacitor comprising a first electrode connected to a second electrode of the TFT and a second electrode connected to an active level shift (ALS) line; and
a liquid crystal device comprising a first electrode connected to the second electrode of the TFT and a second electrode connected to a common voltage line.

17. The LCD device of claim 12, wherein the noise removal unit is further configured to reduce noise coupled between the gate lines and the data lines.

18. The LCD device of claim 12, wherein the noise removal unit is further configured to reduce noise coupled between an active level shift (ALS) line and the data lines.

19. The LCD device of claim 18, wherein the noise removal unit is further configured to reduce noise coupled between the gate lines and the data lines.
